(19) United States
(12) Patent Application Publication
(10) Pub. No.: US 2025/0110985 A1
(43) Pub. Date: Apr. 3, 2025

(54) PERSONALIZED AI ASSISTANCE USING AMBIENT CONTEXT

(71) Applicant: Microsoft Technology Licensing, LLC, Redmond, WA (US)

(72) Inventors: Justin James WAGLE, Pacifica, CA (US); Rogerio BONATTI, Bellevue, WA (US)

(73) Assignee: Microsoft Technology Licensing, LLC, Redmond, WA (US)

(21) Appl. No.: 18/478,998

(22) Filed: Sep. 30, 2023

(51) Int. Cl. G06F 16/583; G06F 40/30; G06V 10/82

(52) U.S. Cl. CPC G06F 16/5846; G06F 40/30; G06V 10/82

(57) ABSTRACT

Large language models (LLMs) are able to provide robust results based on specified formatting and organization. Traditionally, however, users must form detailed queries to obtain desired results in a desired format. Accordingly, although LLMs are designed to receive natural language input, users often lack the skill, knowledge, or patience to utilize LLMs to their full potential. Ambient information and user history associated with device screenshots are leveraged to provide proactive artificial-intelligence (AI) assistance and query resolution in an LLM environment. In particular, screenshots associated with a computer display are continuously captured and analyzed to detect activity triggers for plugins, for example. In response to detecting an activity trigger, local context associated with one or more prior screenshots is collected. The collected context is then used to inform the plugin for performing the task, thereby reducing the burden placed on the user to input the required information.

### BACKGROUND

Large language models (LLMs), or multimodal machine learning models, provide powerful information retrieval for nearly any query. Moreover, LLMs are able to provide results based on specified formatting and organization. Traditionally, however, users must form detailed queries to obtain desired results in a desired format. Accordingly, although LLMs are designed to receive natural language input, users often lack the skill, knowledge, or patience to utilize LLMs to their full potential.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to leveraging ambient information and user history associated with device screen captures to provide proactive artificial-intelligence (AI) assistance and query resolution in an LLM environment. In particular, the present application continuously captures and analyzes screenshots associated with a computer display. An activity trigger may be detected when a current screenshot matches a trigger screenshot associated with an application (e.g., plugin application) that directly or indirectly performs a task related to the current screenshot, for example. In response to detecting the activity trigger, local context associated with one or more previous screenshots is collected. The collected context is then used to inform the application (e.g., triggered plugin) for performing the task, thereby reducing the burden placed on the user to input the required information. In response to user approval, for example, the task may then be performed by the triggered plugin with minimal user effort. In this way, the present application anticipates user needs and provides tangible assistance for meeting those needs.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which one or more machine learning (ML) models may be used according to aspects of the present disclosure.

FIG. 2A-2C illustrate examples of capturing and processing a screenshot of a window provided on a computer display according to aspects described herein.

FIGS. 3A-3D illustrate an overview of an example determining an activity trigger for calling a plugin according to aspects described herein.

FIGS. 4A-4B illustrate an overview of an example method for using one or more ML models to detect an activity trigger for calling a plugin according to aspects described herein.

FIGS. 5A and 5B illustrate overviews of an example generative machine learning model that may be used according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As detailed above, aspects of the present application relate to leveraging ambient information and user history associated with device screen captures to provide proactive artificial-intelligence (AI) assistance and query resolution in an LLM environment, enabling a more personalized and context-aware AI environment and enhancing user experience. In particular, the present application continuously captures and analyzes screenshots associated with a computer display. An activity trigger may be detected when a current screenshot matches a trigger screenshot associated with an application (e.g., plugin application) that directly or indirectly performs a task related to the current screenshot, for example. In response to detecting the activity trigger, local context associated with one or more previous screenshots is collected. The collected context is then used to inform the application (e.g., triggered plugin) for performing the task, thereby reducing the burden placed on the user to input the required information. In response to user approval, for example, the task may then be performed by the triggered plugin with minimal user effort. In this way, the present application anticipates user needs and provides tangible assistance for meeting those needs, thereby reducing user burden for query input, improving the accuracy of relevant suggestion-making even with limited data, and improving user productivity. In some aspects, processing by ML models may be performed locally, providing real-time responsiveness.

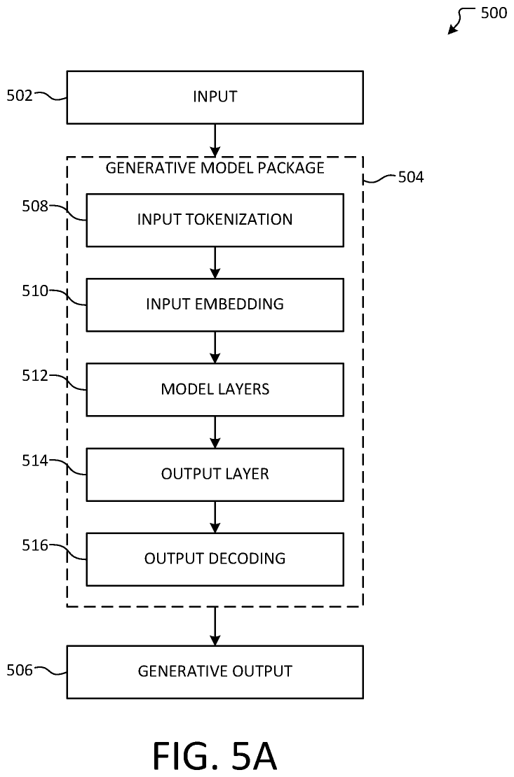

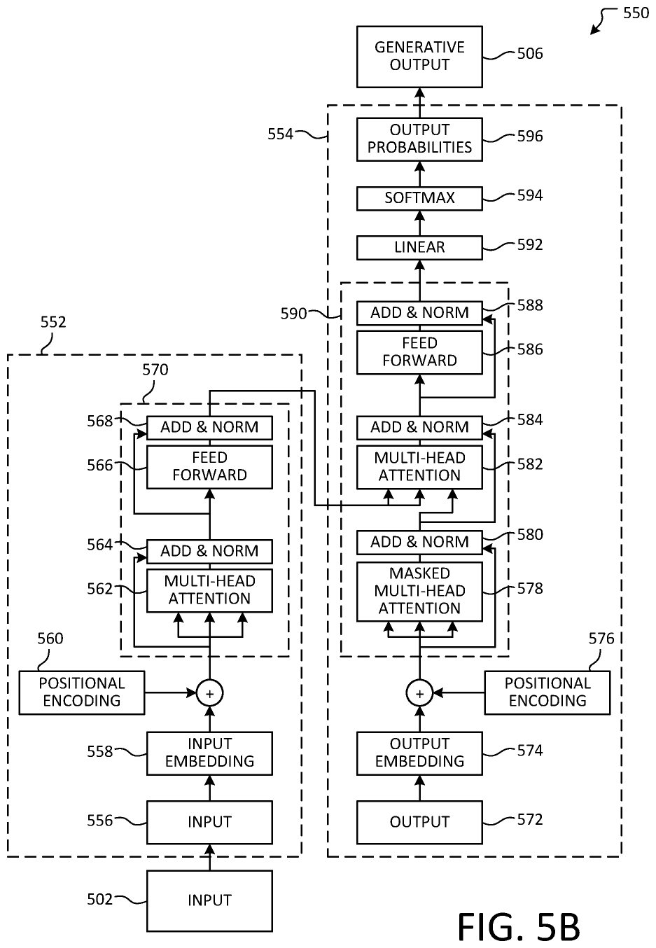

In examples, a generative model (also generally referred to herein as a type of machine learning (ML) model) may be used according to aspects described herein and may generate any of a variety of output types (and may thus be a multimodal generative model, in some examples). For example, the generative model may include a generative transformer model and/or a large language model (LLM), a generative image model, or the like. Example ML models include, but are not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B.

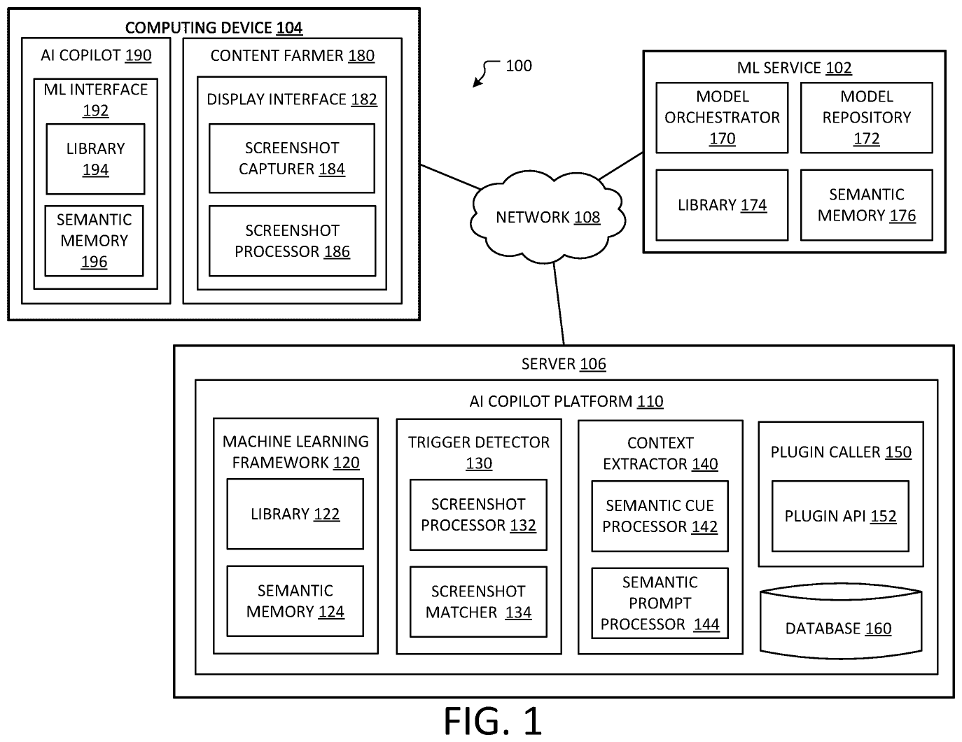

FIG. 1 illustrates an overview of system 100 in which one or more machine learning (ML) models may be used according to aspects of the present disclosure. As illustrated, system 100 includes machine learning service 102, computing device 104, server 106, and network 108. In examples, machine learning service 102, computing device 104, and server 106 communicate via network 108, which may comprise a local area network, a wireless network, or the Internet, or any combination thereof, among other examples.

As illustrated, machine learning service 102 includes model orchestrator 170, model repository 172, library 174, and semantic memory store 176. In examples, machine learning service 102 receives a request from computing device 104 (e.g., from AI copilot application 180) and/or from server 106 (e.g., from AI copilot platform 110) to generate model output. In aspects, the request may include input (e.g., content and/or context) generated by and/or received by AI copilot 180 or AI copilot platform 110. For example, the request may have an associated prompt template, which is used to generate a prompt (e.g., including input and/or context) that is processed using a corresponding ML model to generate model output accordingly. In other examples, an ML model may not need an associated prompt template with the request, as may be the case when prompting is not used by the ML model when processing input to generate model output.

The received request is processed by model orchestrator 170, which may identify one or more ML models from model repository 172 and process the input accordingly. In an example, model orchestrator 170 processes the request to generate the model output (e.g., using one or more models of model repository 172). As noted above, the request may include input (e.g., content and/or context) and/or a prompt (e.g., input and/or context). For example, the request may include a current screenshot and/or one or more trigger screenshots defined for each of a library of plugins (e.g., input). The model output may include detecting an activity trigger associated with a plugin of the library of plugins. In another example, the request may include semantic screenshots and semantic cues defined for the triggered plugin (e.g., input) and the model output may include determining one or more semantic screenshots that are relevant to the triggered plugin. In yet another example, the request may include the one or more relevant screenshots and a semantic prompt defined for the triggered plugin (e.g., input) and the model output may include extracting one or more entities from the one or more relevant screenshots as context for executing the triggered plugin. As should be appreciated, the request may include any combination of content and/or context and the above examples describing various inputs should not be considered as limiting in any way. Input may be received or collected from various sources, for example, current screenshots, semantic screenshots from memory, trigger screenshots defined for various plugins, semantic cues defined for a particular plugin, a semantic prompt defined for a particular plugin, and the like. As should be appreciated, the above examples should not be considered as limiting in any way. Moreover, as the disclosed system may continuously capture and process current screenshots (e.g., new input) to continuously augment previous model outputs (e.g., previous activity triggers) at any stage of analysis.

In another example, the request includes context with which the request is to be processed (e.g., from semantic memory store 124 of server 106). As a further example, the request includes an indication of context in semantic memory store 176 and/or 196, such that model orchestrator 170 obtains the context from semantic memory store 176/196 accordingly. Such aspects may be used in instances where machine learning framework 120 and/or machine learning interface 192 perform aspects similar to model orchestrator 170.

Model repository 172 may include any number of different ML models. For example, model repository 172 may include foundation models, language models, speech models, video models, and/or audio models. As used herein, a foundation model is a model that is pre-trained on broad data that can be adapted to a wide range of tasks (e.g., models capable of processing various different tasks or modalities). In examples, a multimodal machine learning model of model repository 172 may have been trained using training data having a plurality of content types. Thus, for input associated with given content of a content type, an ML model of model repository 172 may generate model output having any of a variety of associated content types. It will be appreciated that model repository 172 may include a foundation model as well as a model that has been finetuned (e.g., for a specific context and/or a specific user or set of users), among other examples.

Turning now to computing device 104, computing device 104 includes content farmer 180, associated with display interface 182 and including screenshot capturer 184 and screenshot processor 186. For example, screenshot capturer 184 may continuously capture and analyze screenshots associated with display interface 182 of a computer display. For example, screen-based raw data and metadata may be collected and recorded every few seconds (e.g., 2 seconds) for one or more windows of a computing display. In aspects, a window may include content associated with an application (e.g., a word processing application, spreadsheet application, presentation application, email application, conferencing application, calendar application, task application, social media application, collaboration application, artificial intelligence (AI) application, media viewing/editing application, and the like), a website (e.g., viewed via a URL on a browser), an app or plugin (e.g., viewed via an application programming interface (API)), and the like.

Screenshot processor 186 may process captured screenshots using one or more machine learning (ML) models. In examples, screenshot processor 186 (and/or screenshot processor 132 of server 106) may implement one or more machine-learning (ML) models running on neural processing units (NPUs) to extract text and images and convert them into semantic embeddings (e.g., vectors) representing the text or images, as described further with respect with FIGS. 5A-5B. In further embodiments, audio data associated with captured screenshots may also be transcribed and converted to word embeddings. Memory may be reduced by processing and storing screenshots associated with at least a minimal change threshold. For example, an optical character recognition (OCR) model may be run over captured screenshots and compared with previous screenshots. When the change is less than a predetermined threshold, the screenshot may be dropped or skipped.

In some examples, screenshot processor 186 (and/or screenshot processor 132 of server 106) may process screenshots using a screen-region detection (SRD) model to segment blocks of text and/or images for high quality data extraction. Each block may include sub-content (e.g., data) associated with a screenshot. In further aspects, screenshot processor 186 (and/or screenshot processor 132 of server 106) may process screenshots using a semantic embedding model (EMB) that converts the segment blocks to a set of embeddings (e.g., vectors) representing the sub-content. For example, each vector may include a plurality of dimensions uniquely representing content of each segment block. In other examples, a different data detection and/or extraction model may be used to process screenshots. For example, a first ML model may be trained to process image content and a second ML model may be trained to process textual content associated with a screenshot. When a screenshot includes a plurality of content types, more than one ML model may be selected.

The AI copilot application 180 hosted by computing device 104 may include a machine learning (ML) interface 192, library 194, and semantic memory 196, similar to the machine learning (ML) framework 120, library 122, and semantic memory story 124 hosted by the AI copilot platform 110 and/or the model orchestrator 170, library 174, and semantic memory 176 hosted by ML service 102. It will therefore be appreciated that the disclosed aspects may be implemented according to any of a variety of paradigms. For example, any stage of input processing may be performed client side (e.g., by ML interface 192), server side (e.g., by ML framework 120), third-party service side (e.g., model orchestrator 170), or any combination thereof, among other examples. For instance, model orchestrator 170 may perform a first ML evaluation associated with content input to provide a model output (e.g., detection of an activity trigger for a plugin), while a second ML evaluation (e.g., context extraction) may be performed by ML framework 120 based on the model output of the first ML model. In other aspects, the client-side ML interface 192 may be provided as part of an operating system of computing device 104 (e.g., as a service, an application programming interface (API), and/or a framework) and may be made available as a library (e.g., library 194) that is included with AI copilot application 180, or may be provided as a standalone application, among other examples. ML framework 120 may be provided as part of a service of AI copilot platform 110 (e.g., as an application programming interface (API)) or may be made available as a library (e.g., library 122) that is included with AI copilot platform 110, among other examples.

Turning now to server 106, server 106 includes AI copilot platform 110, which includes machine learning framework 120, trigger detector 130, context extractor 140, and plugin caller 150. As described above, AI copilot platform 110 monitors and captures screenshots of windows (e.g., foreground windows) associated with performing first activities on a computing device (e.g., computing device 104), detects activity triggers for plugins directly or indirectly related to the first activities, and extracts context for executing the triggered plugins.

In examples, aspects of ML framework 120, which includes library 122 and semantic memory store 124, are similar to model orchestrator 170 and are therefore not necessarily redescribed in detail. For example, in addition to or as an alternative to processing and analyzing captured screenshots by model orchestrator 170, ML framework 120 may process captured screenshots, detect activity triggers associated with relevant plugins, extract context for executing the triggered plugins, and/or any aspect or stage of such analysis, according to aspects described herein. In other examples, ML framework 120 may provide a request and an indication of input to ML service 102, such that the model output is generated by ML service 102 and is received by server 106 in response. Accordingly, ML framework 120 may manage analysis of the input (e.g., generating subsequent requests to ML service 102 for subsequent detection of relevant plugins, context extraction, etc.). In other examples, various other modules of the AI copilot platform 110 may provide input and/or requests to the ML service 102, as described further below.

As further illustrated, AI copilot platform 110 includes trigger detector 130, which includes screenshot processor 132 and screenshot matcher 134. Screenshot processor 132 may continuously receive screenshots of windows every few seconds (e.g., from screenshot capturer 184 and/or screenshot processor 186 associated with computing device 104). In examples, screenshot processor 132 may function similarly to screenshot processor 186 of computing device 104, as described above, to implement one or more machine-learning (ML) models running on neural processing units (NPUs) to extract text and images and convert them into semantic embeddings (e.g., vectors) representing the text or images, as described further with respect with FIGS. 5A-5B. In some examples, screenshot processor 132 (and/or screenshot processor 186) may process screenshots using a screen-region detection (SRD) model to segment blocks of text and/or images for high quality data extraction. Each block may include sub-content (e.g., data) associated with a screenshot. In further aspects, screenshot processor 132 (and/or screenshot processor 186) may process screenshots using a semantic embedding model (EMB) that converts the segment blocks to a set of embeddings (e.g., vectors) representing the sub-content.

Screenshot matcher 134 may then determine a similarity of a captured screenshot (e.g., a current screenshot) to trigger screenshots defined for each of a library of plugins (e.g., stored in library 122/174/194 or accessible via plugin API 152). Similar to the current screenshot, the trigger screenshots may be processed using one or more ML models. For instance, each trigger screenshot may be processed using a screen-region detection (SRD) model to segment blocks of text and/or images; thereafter, each segment block may be processed using a semantic embedding model (EMB) that converts the segment blocks to a set of embeddings (e.g., vectors) representing the content of the segment block. The vectors representing the current screenshot may then be compared to vectors representing each of the trigger screenshots for each of the library of plugins. Trigger detector 130 may detect an activity trigger for a plugin when one or more trigger screenshots defined for the plugin match (e.g., have a greatest similarity to) the current screenshot.

Upon detecting an activity trigger for a plugin, context extractor 140 may process a set of semantic screenshots (e.g., captured over the past several months) to identify one or more semantic screenshots relevant to the plugin. For instance, semantic cue processor 142 may compare semantic cues defined for the triggered plugin to the set of semantic screenshots to identify one or more semantic screenshots having a greatest similarity to the semantic cues for the triggered plugin. In some aspects, the set of semantic screenshots and/or the semantic cues may be processed by one or more ML models (e.g., an SRD and/or an EMB) to make the comparison. Once one or more relevant semantic screenshots are identified (e.g., top-K semantic screenshots), semantic prompt processor 144 may utilize a large language model (LLM) to extract relevant entities from the one or more relevant semantic screenshots according to a semantic prompt defined for the triggered plugin.

Plugin caller 150 may then notify a user regarding the triggered plugin and/or call the triggered plugin to perform a second activity related to the first activity associated with the current screenshot. In aspects, the triggered plugin may be called based on a library (e.g., library 122/174/194) and/or plugin API 152. In some examples, processed screenshots (e.g., current screenshot, trigger screenshots, semantic screenshots), plugins, extracted context, etc., may be stored in database 160.

As may be appreciated by those skilled in the art, the AI copilot platform 110 shown in FIG. 1, may be on a single device wherein the AI copilot platform 110 has the trigger detector 130, the screenshot matcher 134, the context extractor 140 and the plugin caller 150 with a local or cloud plugin api.

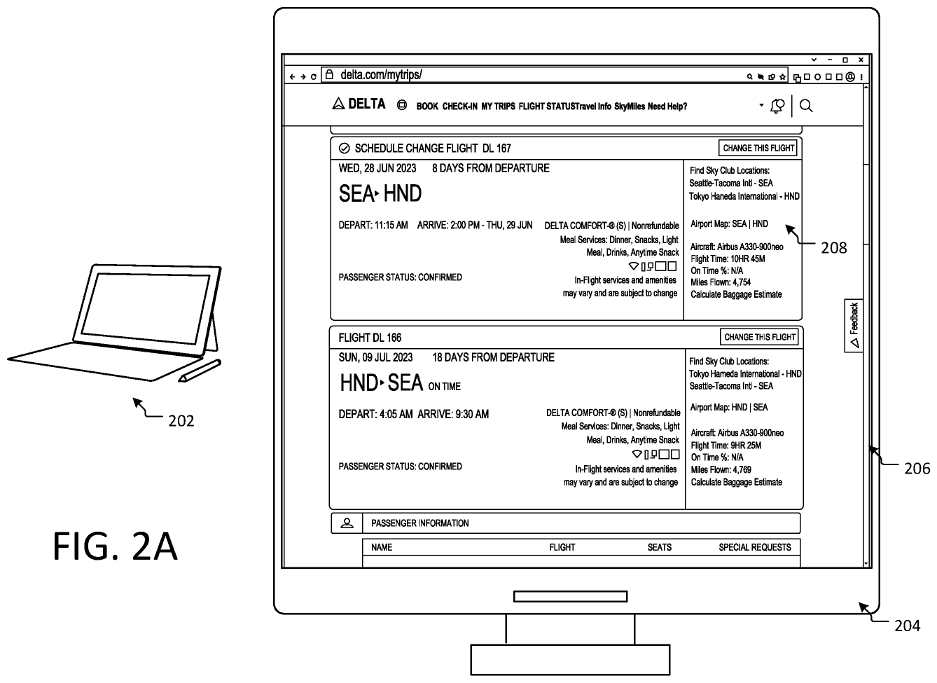

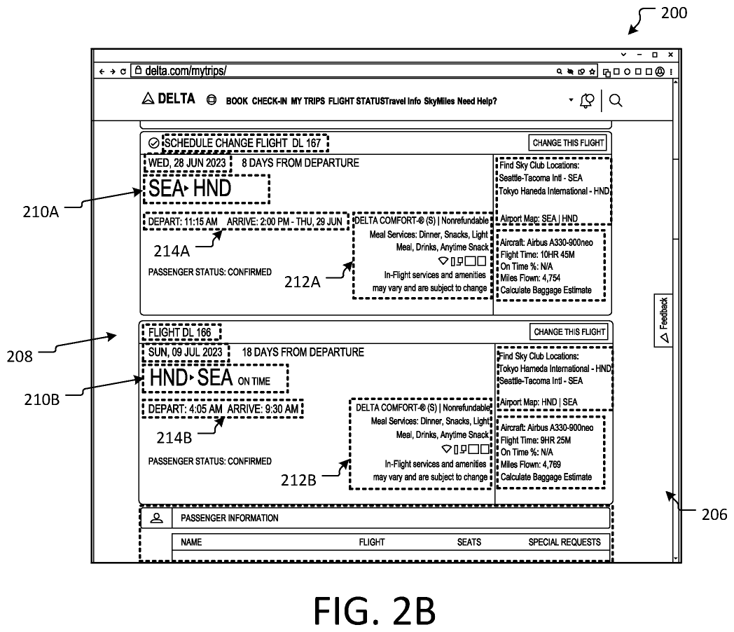

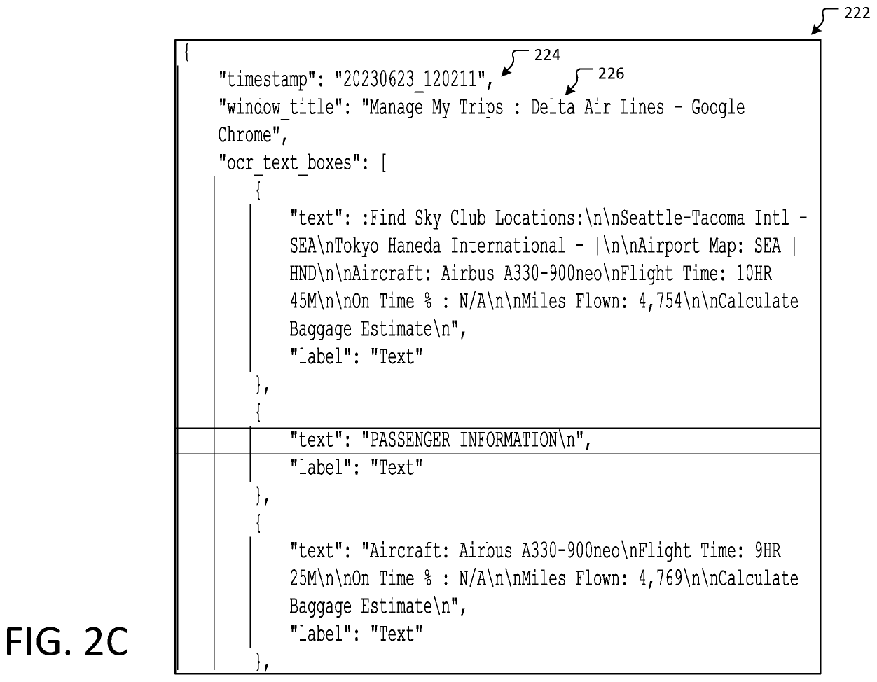

FIG. 2A-2C illustrate examples of capturing and processing a screenshot of a window provided on a computer display according to aspects described herein. FIG. 2A illustrates a display 204 of a computing device 202 (e.g., computing device 104) running an AI copilot application (e.g., AI copilot 190 of FIG. 1) in communication with an AI copilot platform (e.g., AI copilot platform 110 running on server 106) and/or an ML service (e.g., ML service 102). In aspects, an operating system executing on the computing device 202 in communication with a display 204 provides a graphical user interface (e.g., GUI) displaying a window 206 (e.g., a foreground window) including content 208 associated with a website being viewed via a browser.

As detailed above, large language models (LLMs), or multimodal machine learning models, provide powerful information retrieval for nearly any query. Moreover, while LLMs are able to provide robust results based on specified formatting and organization, detailed queries are required to obtain the desired results in the desired format. For example, current systems require the user to provide explicit text input to the LLM, such as typing a query into a text box or specifying a pointer for a particular file to be parsed. Accordingly, although LLMs are designed to receive natural language input, users often lack the skill, knowledge, or patience to form input for utilizing LLMs to their full potential. The present application relates to leveraging ambient information and user history associated with device screen captures (e.g., screenshots) to provide proactive artificial-intelligence (AI) assistance and query resolution in an LLM environment.

In particular, the present application continuously captures and analyzes screenshots (e.g., of window 206) associated with a computer display (e.g., computer display 204). For example, screen-based raw data and metadata may be collected and recorded every few seconds (e.g., 2 seconds) for one or more windows of a computing display (e.g., window 206). A window includes content associated with an application (e.g., a word processing application, spreadsheet application, presentation application, email application, conferencing application, calendar application, task application, social media application, collaboration application, artificial intelligence (AI) application, media viewing/editing application, and the like), a website (e.g., viewed via a URL on a browser), an app or plugin (e.g., viewed via an application programming interface (API)), and the like. In some examples, screenshots of foreground windows may be captured; whereas in other examples, screenshots of foreground and background windows may be captured. A foreground window may be associated with a window in a forward position, which may overlap other windows but is not overlapped by other windows; whereas a background window is in a backward position overlapped by one or more other windows. In some aspects, a graphical user interface may comprise one or more foreground windows and zero, one, or more background windows.

FIG. 2B illustrates captured screenshot 200 of window 206 including content 208 associated with a website being viewed via a browser.

A captured screenshot may be processed by one or more machine-learning (ML) models running on neural processing units (NPUs) to extract text and images and convert them into semantic embeddings (e.g., vectors) representing the text or images, as described further with respect with FIGS. 5A-5B. In further embodiments, audio data may be transcribed and converted to word embeddings. Memory may be reduced by processing and storing screenshots associated with at least a minimal change threshold. For example, an optical character recognition (OCR) model may be run over captured screenshots and compared with previous screenshots. When the change is less than a predetermined threshold, the screenshot may be dropped or skipped.

In some examples, a screen-region detection model may process screenshot 200 to segment blocks of text and/or images for high quality data extraction. As illustrated, the screen-region detection model has identified blocks represented by dashed lines, including blocks 210A-B, 212A-B and 214A-B. Each block may include sub-content (e.g., data) associated with content 208. As illustrated, content 208 relates to a round-trip airline flight and the identified blocks include sub-content related to the flight. For example, blocks 210A-B are associated with FROM-TO destination data, blocks 212A-B are associated with amenities data, blocks 214A-B are associated with departure/arrival time and date data.

In other examples, a different data detection and/or extraction model may be used to process screenshots. In aspects, the one or more ML models may be selected based on the content type and/or format of the sub-content associated with content 208. That is, different ML models may be trained to process different content types and/or formats. For example, a first ML model may be trained to process image content and a second ML model may be trained to process textual content associated with screenshot 200. In some cases, for example when content 208 includes a plurality of content types, more than one ML model may be selected. In some aspects, content 208 or sub-content associated with content 208 may be converted into word embeddings (e.g., vectors). For example, each vector may include a plurality of dimensions uniquely representing content 208 or the sub-content. As should be appreciated, the above examples of processing screenshots are provided for the purposes of explanation and illustration and should not be considered limiting in any way. Other types of processing, either now known or developed in the future, may be utilized without departing from the present disclosure.

FIG. 2C illustrates a representation 222 of screenshot 200 resulting from the processing of screenshot 200 by one or more ML models. As illustrated, data extracted from screenshot 200 is saved in JavaScript Object Notation (.json) format with metadata, including timestamp 224 and window title 226. As should be appreciated, the above example of storing processed screenshot data is provided for the purposes of explanation and illustration and should not be considered limiting in any way. Other types of processing and/or saving data, either now known or developed in the future, may be utilized without departing from the present disclosure.

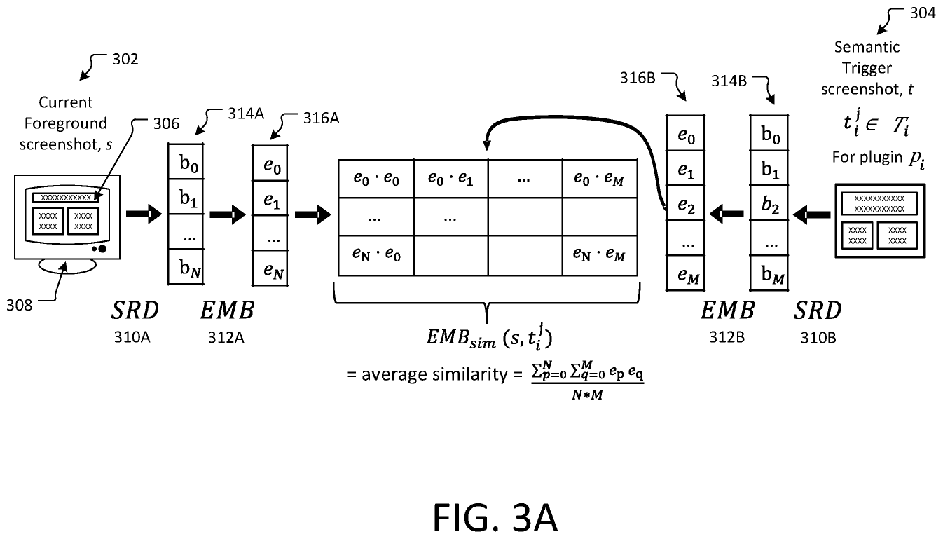

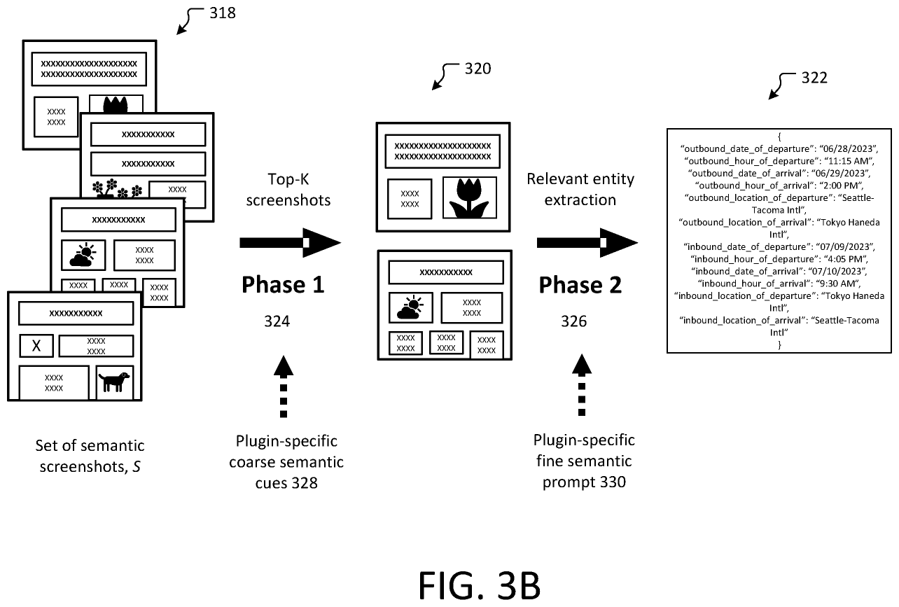

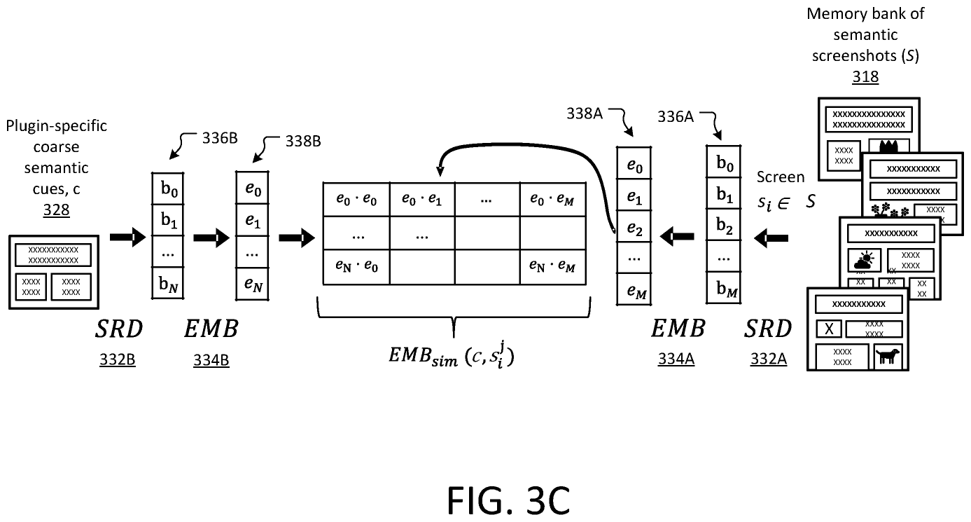

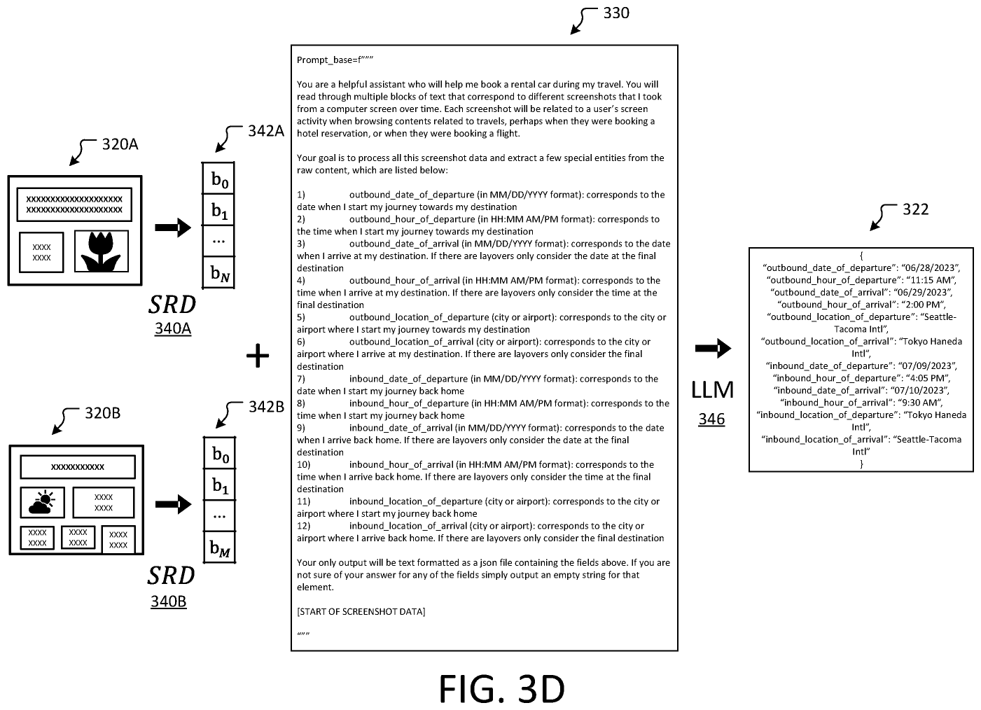

FIGS. 3A-3D illustrate an overview of detecting an activity trigger for calling a plugin according to aspects described herein. FIG. 3A illustrates an overview of a method for detecting an activity trigger based on semantic triggering according to aspects described herein.

Plugin applications (or apps) are software programs often accessed via APIs that enable users to perform limited tasks, such as booking a flight, making a hotel or restaurant reservation, making an online payment, and the like. In aspects, a first activity performed on a computing device may be related to or often precede the use of a plugin to perform a second activity. In this regard, the first activity may be referred to herein as a “activity trigger.” Activity triggers may be detected based on semantic triggers, keyboard triggers, and/or explicit query triggers. For example, developers of a plugin may define activity triggers such that upon their detection, a call to the plugin may be made or offered to a user to facilitate performing the second activity associated with the plugin. In this way, the disclosed system may leverage the powerful processing of LLMs to detect and intuitively respond to user needs without requiring the user to form an explicit query, thereby improving user efficiency and productivity.

With respect to semantic triggering, a plugin developer may define a set of screenshots as semantic triggers. The set of trigger screenshots are associated with activities (e.g., first activities) that often precede use of the plugin. As noted above, screenshots of current windows may be captured substantially continuously, e.g., every few seconds. Upon processing a current screenshot associated with a first activity using one or more ML models, semantic content associated with the current screenshot is compared to the set of trigger screenshots defined for each plugin in a library of plugins. Based on a similarity match, for example, a plugin may be selected from the library as a suggestion for the user to perform a second activity related to or often following the first activity. For example, a user has just finished booking a flight (e.g., first activity). A current screenshot of the booked flight (e.g., screenshot 200) may be processed and compared to a set of trigger screenshots defined for a rental-car plugin. In response to detecting a similarity match between the current screenshot and a trigger screenshot defined for the rental-car plugin, the rental-car plugin may be suggested to the user for renting a car (e.g., second activity) in the destination city associated with the booked flight, for example. In aspects, plugin suggestions may be provided via an AI toolbar displaying currently triggered plugins, an AI button on a keyboard for displaying currently triggered plugins and/or a popup or blinking notification upon triggering a plugin. As should be appreciated, suggested plugins may be provided to the user via any suitable means and the described examples should not be considered limiting in any way.

With respect to keyboard triggering, a plugin developer may define a set of keyboard combinations or clipboard selections as triggers for the plugin. For example, as a user copies a block of text (e.g., first activity), a “smart paste” plugin can be triggered to auto-suggest a pasting location (e.g., second activity). With respect to explicit query triggering, a developer may define terms or phrases associated with performing the second activity as triggers for suggesting the plugin to the user. As should be appreciated, the above examples of defining activity triggers for a plugin are provided for the purposes of explanation and illustration and should not be considered limiting in any way.

As illustrated by FIG. 3A, a current screenshot(s) 302 is captured based on a current window 306 on a display of computing device 308. The current screenshot(s) 302 may be compared (e.g., using a screen-region detection model) to a trigger screenshot (tᵢ) 304 of a set of trigger screenshots (Tᵢ) defined for a plugin (pᵢ) of a library of plugins (P). In aspects, each plugin (pᵢ) of the library of plugins (P) is associated with a defined set of trigger screenshots (Tᵢ). In aspects, a first screen region detection function (SRD) 310A maps current screenshot 302 to a first set of bounding boxes 314A {b₀, b₁, . . . b_{N}}, and a first semantic embedding model (EMB) 312A maps the first set of bounding boxes 314A to a first set of embeddings 316A {e₀, e₁, . . . e_{N}}. Similarly, semantic memory (e.g., semantic memory 124/176/196 of FIG. 1) may store embeddings for the set of trigger screenshots (Tᵢ) defined for each plugin (pᵢ) in a library (e.g., library 122/174/194 of FIG. 1). For example, as illustrated, a second SRD 310B (which may be the same or different model as first SRD 310A) maps the trigger screenshot 304 to a second set of bounding boxes 314B {b₀, b₁, . . . b_{M}}, and a second semantic embedding model (EMB) 312B (which may be the same or different model as first EMB 312A) maps the second set of bounding boxes 314B to a second set of embeddings 316B {e₀, e₁, . . . e_{M}}.

A semantic similarity between the current screenshot 302 and the trigger screenshot 304 is represented by EMBₛᵢₘ (s, tᵢ^{j}), which is an average similarity

$$\frac{{\sum }_{p = 0}^{N} {\sum }_{q = 0}^{M} {e}_{p} {e}_{q}}{N * M} .$$

The semantic similarity between the current screenshot and a plugin is calculated as the maximum similarity between the screenshot and any of the trigger screenshots (tᵢ^{j}) within the set of trigger screenshots (Tᵢ), where

$${EMB}_{sim} ( s , {p}_{i} ) = {max}_{{t}_{i}^{j} ∈ {T}_{i}} {EMB}_{sim} ( s , {t}_{i}^{j} ) .$$

The most relevant plugin(s) (e.g., at least one identified plugin) for that semantic context (e.g., associated with the current screenshot 302) may then be selected based on ranking the EMBₛᵢₘ (s, pᵢ) scores for each plugin (pᵢ). In aspects, any of a number of embedding models may be implemented, including Turing ULR V6 Space, HuggingFace ms-marco-MiniLM-L6-cos-v5, and the like.

FIG. 3B illustrates an overview of a method for retrieving local context in response to detecting an activity trigger and identifying at least one plugin according to aspects described herein.

In aspects, in response to detecting an activity trigger and identifying at least one plugin (as described with reference to FIG. 3A), information from the user's computer memory may be retrieved to aid execution of the identified plugin. This information may be composed of specific entities (dates, times, places) or may contain blocks of text used as context to aid execution of the identified plugin. In aspects, a two-phase approach may be performed, including a coarse evaluation to identify top-K relevant semantic screenshots from memory and then a fine entity extraction may be conducted on the top-K relevant semantic screenshots.

As noted above, screenshots of user activity (e.g., screenshots of foreground windows) may be captured every few seconds. In aspects, screenshots associated with a minimum threshold of change may be processed, mapped to a set of embeddings, and stored in semantic memory (e.g., semantic memory 124/176/196 of FIG. 1) as a set of semantic screenshots(S) 318. In aspects, the set of semantic screenshots 318 may be associated with several months of screenshots captured, processed, and stored based on user activity. Additionally, a set of coarse semantic cues (e.g., coarse semantic cues 328) a fine semantic prompt (e.g., fine semantic prompt 330) may be defined for the identified plugin (e.g., predefined by the developer of the identified plugin(s) from FIG. 3A). In aspects, the plugin developer may specify additional heuristics, for example, such as instructions to consider only the last few minutes of user activity.

During a first phase 324 of processing by one or more ML models, each of the set of semantic screenshots 318 may be compared to the coarse semantic cues 328. As a result of the first phase 324 of processing, one or more relevant semantic screenshots 320 (e.g., top-K semantic screenshots) may be identified based on highest scoring semantic similarity to the coarse semantic cues 328. During a second phase 326, based on the fine semantic prompt 330, entities 322 may be extracted from the one or more relevant semantic screenshots 320 to aid in the execution of the identified plugin. In aspects, a large language model (LLM) may process the fine semantic prompt 330 to extract one or more entities 322 from the one or more relevant semantic screenshots 320. In further aspects, the extracted entities 322 may be output based on formatting specified by the fine semantic prompt 330, the formatting of the extracted entities 322 suited for populating at least one field associated with executing the identified plugin. For example, the arrival date and arrival time (e.g., entities 322) may be extracted from a relevant semantic screenshot 320 associated with a flight booking and the extracted entities 322 (e.g., arrival date and time) may then be used to populate fields associated with reserving a rental car using the identified plugin. Moreover, other entities 322, such as username, address, phone number, etc., may be extracted from the same or different relevant semantic screenshot 320 and used to populate other fields associated with reserving a rental car using the identified plugin, for example.

Thus, in addition to identifying a plugin for performing a second activity (e.g., reserving a rental car) directly or indirectly related to performing a first activity (e.g., booking a flight), the present disclosure extracts relevant content or context (e.g., entities 322) for executing the identified plugin. In this way, not only is the user benefited by the automatic identification of the relevant plugin, but also by the automatic populating of the identified plugin with relevant entities for execution.

FIG. 3C illustrates an overview of the first phase of a method for retrieving local context in response to detecting an activity trigger and identifying a relevant plugin according to aspects described herein.

As noted above, in response to detecting an activity trigger and identifying a relevant plugin (as described with reference to FIG. 3A), information from the user's computer memory may be retrieved to aid execution of the identified plugin. In aspects, in a first phase of processing (e.g., first phase 324), may utilize a semantic embedding model to identify one or more relevant semantic screenshots from a set of semantic screenshots 318 stored in semantic memory (e.g., semantic memory 124/176/196 of FIG. 1). According to other aspects, simpler methods such as TF-IDF content retrieval may be used.

As illustrated, coarse semantic cues (c) 328 are compared using a screen-region detection model to each semantic screenshot (Si) 318 of a set of semantic screenshots(S) 318 stored in semantic memory. As noted above, screenshots of windows (e.g., foreground windows) associated with user activity may be captured every few seconds. Screenshots meeting a minimal change threshold, for example, may be processed using a first screen region detection function (SRD) 332A to map each screenshot to a first set of bounding boxes 336A {b₀, b₁, . . . b_{M}}, and a first semantic embedding model (EMB) 334A to map the first set of bounding boxes 336A to a first set of embeddings 338A {e₀, e₁, . . . e_{M}} to form the set of semantic screenshots(S) 318. The set of semantic screenshots(S) 318 may then be stored in semantic memory (e.g., semantic memory 124/176/196 of FIG. 1). Similarly, a second SRD 332B (which may be the same or different model as first SRD 332A) maps each coarse semantic cue 328 to a second set of bounding boxes 336B {b₀, b₁, . . . b_{N}}, and a second semantic embedding model (EMB) 334B (which may be the same or different model as first EMB 334A) maps the second set of bounding boxes 336B to a second set of embeddings 338B {e₀, e₁, . . . e_{N}}. The embeddings for the coarse semantic cues 328 defined for the identified may be stored in a library (e.g., library 122/174/194 of FIG. 1).

A semantic similarity between the coarse semantic cues 328 and each semantic screenshot 318 is represented by EMBₛᵢₘ (c, sᵢ^{j}). The most relevant semantic screenshots 320 (e.g., top-K relevant semantic screenshots) for that semantic context (e.g., associated with the identified plugin) may then be selected based on ranking the EMBₛᵢₘ (c, sᵢ^{j}) scores for each semantic screenshot (sᵢ). In aspects, similar to the method described with reference to FIG. 3A, any of a number of embedding models may be implemented, including Turing ULR V6 Space, HuggingFace ms-marco-MiniLM-L6-cos-v5, and the like.

FIG. 3D illustrates an overview of the second phase of a method for retrieving local context in response to detecting an activity trigger and identifying a relevant plugin according to aspects described herein.

Upon identifying the most relevant semantic screenshots 320A-B (e.g., top-K relevant semantic screenshots) for a semantic context (e.g., associated with the identified plugin), the second phase (e.g., second phase 326) of processing may be applied to extract relevant entities from the relevant semantic screenshots 320A-B. In aspects, specific information needed for the identified plugin may be dispersed within the relevant semantic screenshots 320A-B. In aspects, a large language model (e.g., LLM 346) may be consulted to extract relevant entities (e.g., relevant entities 322) from raw data.

For example, relevant semantic screenshot 320A may be processed using a first screen region detection function (SRD) 340A (which may be the same or different SRD applied to the semantic screenshots 318) to map relevant semantic screenshot 320A to a first set of bounding boxes 342A {b₀, b₁, . . . b_{N}}. Similarly, relevant semantic screenshot 320B may be processed using a second screen region detection function (SRD) 340B (which may be the same or different function as first SRD 340A) to map relevant semantic screenshot 320B to a second set of bounding boxes 342B {b₀, b₁, . . . b_{M}}. In aspects, a large language model (LLM) may process a fine semantic prompt 330 (e.g., defined by a developer of the identified plugin) to extract one or more entities 322 from the one or more relevant semantic screenshots 320A-B. Fine semantic prompt 330 may processed using LLM 346 to extract relevant entities 322 from content associated with the first bounding boxes 342A and/or the second bounding boxes 342B. In aspects, relevant entities 322 may be extracted by LLM 346 in a format specified by the fine semantic prompt 330 that is suited for populating one or more fields of a template associated with executing the identified plugin. As should be appreciated, other methods for extracting relevant entities 322 from the relevant semantic screenshots 320A-B (e.g., TF-IDF content retrieval) may be used and the described methods should not be considered limiting in any way.

Thus, in addition to identifying a plugin for performing a second activity (e.g., reserving a rental car) directly or indirectly related to performing a first activity (e.g., booking a flight), the present disclosure extracts relevant content or context (e.g., entities 322) for executing the identified plugin. In this way, not only is the user benefited by the automatic identification of the relevant plugin, but also by the automatic populating of the identified plugin with relevant entities for execution.

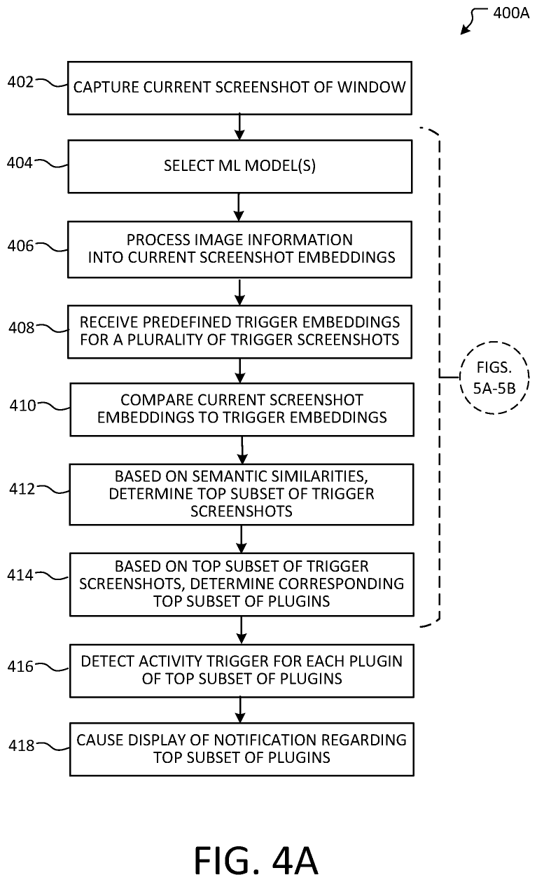

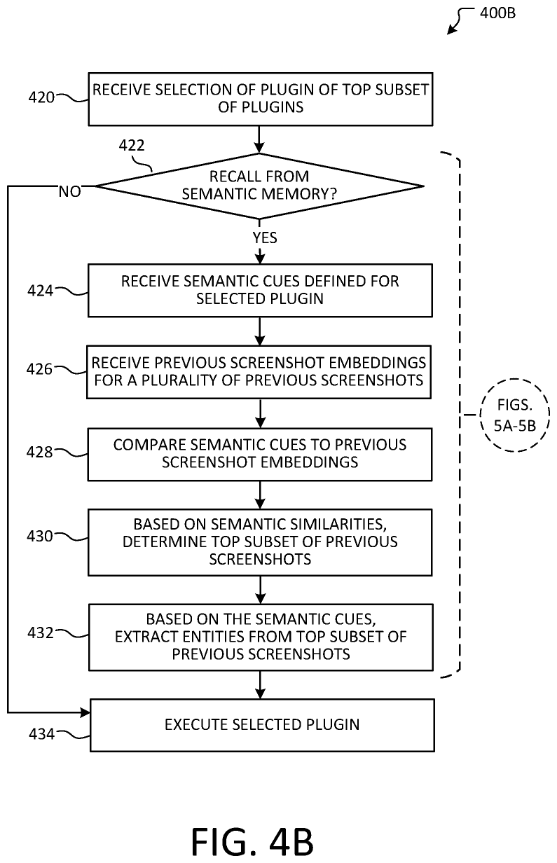

FIG. 4A illustrates an overview of an example method 400A for using one or more ML models to detect an activity trigger for calling a plugin according to aspects described herein. In examples, aspects of method 400A are performed by a model orchestrator (e.g., model orchestrator 170) and/or by a machine learning framework (e.g., machine learning framework 120) and/or by a machine learning interface (e.g., machine learning interface 192), among other examples.

As illustrated, method 400A begins at capture operation 402, where a current screenshot of a window may be captured. In aspects, without limitation, the window may be associated with an application, a website, a plugin, a search engine, or the like, for performing a first activity. For example, the first activity may include activities such as booking a flight, reserving a restaurant, booking a hotel, making an online purchase, performing a search on a search engine, and the like.

At select operation 404, one or more ML models of a multimodal ML model may be selected for processing the current screenshot. In aspects, one or more ML models may be selected based on a content type and/or format of the current screenshot. That is, different ML models may be trained to process different content types and/or formats. For example, a first ML model may be trained to process image content and a second ML model may be trained to process textual content. In some cases, for example when the current screenshot includes different types of content, more than one ML model may be selected. As should be appreciated, a different ML model may be selected to process the current screenshot, the plurality of first trigger screenshots, and/or the plurality of second trigger screenshots.

At process operation 406, image information of the current screenshot may be processed into a set of current screenshot embeddings. In some aspects, the current screenshot may be processed based on a first selected machine learning (ML) model, such as a screen region detection function (SRD), to map the current screenshot to a set of bounding boxes. Moreover, the current screenshot may be processed using a second selected ML model, such as semantic embedding model (EMB), to map the set of bounding boxes to the set of current screenshot embeddings for the current screenshot. As should be appreciated, the image information may be additionally or alternatively processed by one or more other ML models into the set of current screenshot embeddings.

At receive operation 408, a plurality of trigger embeddings for a plurality of trigger screenshots may be received. In aspects, a set of trigger embeddings may be defined for each plugin of a plurality of plugins, thereby generating the plurality of trigger embeddings (e.g., stored in a library 122/174/194 of FIG. 1). In some aspects, the plurality of trigger embeddings may have been generated based on processing the plurality of trigger screenshots using the first selected machine learning (ML) model, e.g., a screen region detection function (SRD), to map each trigger screenshot to a set of bounding boxes, and using the second selected ML model, e.g., a semantic embedding model (EMB), to map the set of bounding boxes to a set of trigger embeddings for each trigger screenshot. As should be appreciated, the trigger screenshots may be additionally or alternatively processed by one or more other ML models into the plurality of trigger embeddings.

At compare operation 410, the set of current screenshot embeddings is compared to the plurality of trigger embeddings.

At determine operation 412, output is generated by the selected one or more ML models. For example, semantic similarities between the set of current screenshot embeddings and the plurality of trigger embeddings are calculated as the maximum similarity between the current screenshot and any of the trigger screenshots (t₁^{j}) within the plurality of trigger screenshots (T₁), where

$${EMB}_{sim} ( s , {p}_{1} ) = {max}_{{t}_{1}^{j} ∈ {T}_{1}} {EMB}_{sim} ( s , {t}_{1}^{j} ) .$$

Based on a predetermined threshold of similarity, for instance, a top subset of trigger screenshots may be determined.

At determine operation 414, based on the top subset of trigger screenshots, a corresponding top subset of plugins may be determined.

In aspects, one or more operations 404-414 may be implemented using a generative machine learning model, described further with reference to FIGS. 5A-5B.

At detect operation 416, an activity trigger may be detected for each plugin of the top set of plugins.

At cause operation 418, display of a notification indicating an activity trigger for each plugin of the top subset of plugins may be caused. In aspects, each plugin of the top subset of plugins is selectable from the notification.

FIG. 4B illustrates an overview of an example method 400B for using one or more ML models to extract entities from previous screenshots for use in executing a selected plugin, according to aspects described herein. In examples, aspects of method 400B are performed by a model orchestrator (e.g., model orchestrator 170) and/or by a machine learning framework (e.g., machine learning framework 120) and/or by a machine learning interface (e.g., machine learning interface 192), among other examples.

As illustrated, method 400B begins at receive operation 420, where a selection of a plugin is received. In aspects, the plugin may be selected from a notification identifying activity triggers for a top subset of plugins (e.g., with reference to operation 418 of FIG. 4A).

In aspects, information from the user's computer memory may be retrieved to aid execution of the selected plugin. This information may be composed of specific entities (dates, times, places) or may contain blocks of text used as context to aid execution of the selected plugin. In aspects, a two-phase approach may be performed, including a coarse evaluation to identify top-K relevant semantic screenshots from memory and then a fine entity extraction may be conducted on the top-K relevant semantic screenshots. As noted above, screenshots of user activity (e.g., screenshots of foreground windows) may be captured every few seconds. In aspects, screenshots associated with a minimum threshold of change may be processed, mapped to a set of embeddings, and stored in semantic memory (e.g., semantic memory 124/176/196 of FIG. 1) as a set of previous screenshot embeddings (e.g., semantic screenshots). In aspects, the set of previous screenshot embeddings may be associated with several months of previous screenshots captured, processed, and stored based on user activity.

At determination operation 422, it may be determined whether to recall context from semantic memory (e.g., semantic memory 124/176/196). In aspects, the determination of whether to recall context may be based on a prompt template. For example, the prompt template may indicate that context should be obtained from the semantic memory store and/or may include an indication as to what context should be obtained, if available. As another example, it may be automatically determined to recall context from the semantic memory store, as may be determined based on previous input (e.g., selected plugin) that used the same or a similar prompt. If it is determined to recall context from the semantic memory, flow branches “YES” to receive operation 424. It will be appreciated that context may be obtained from any of a variety of sources, including, but not limited to, a user's computing device (e.g., computing device 104 in FIG. 1) and/or a machine learning service (e.g., machine learning service 102), among other examples. By contrast, if it is instead determined not to recall context from the semantic memory store, flow instead branches “NO” to execute operation 434, which is discussed below.

At receive operation 424, semantic cues defined for the selected plugin may be received, e.g., from semantic memory (e.g., semantic memory 124/176/196). In aspects, the semantic cues may be defined by the developer for the selected plugin and may relate to semantic cues on screens often preceding the first plugin. In aspects, the plugin developer may specify additional heuristics, for example, such as instructions to consider only the last few minutes of user activity.

At receive operation 426, a plurality of previous screenshot embeddings (e.g., semantic screenshots) for a plurality of previous screenshots may be received, e.g., from semantic memory (e.g., semantic memory 124/176/196). In some aspects, a screen region detection function (SRD) and/or a semantic embedding model (EMB) may have been used to process the plurality of previous screenshots. The SRC may have been used to process the plurality of previous screenshots to map each previous screenshot to a set of bounding boxes, and the EMB may have been used to map the set of bounding boxes to a set of previous screenshot embeddings for each previous screenshot.

At compare operation 428, the semantic cues defined for the selected plugin are compared to the previous screenshot embeddings.

At determine operation 430, based on semantic similarities between the semantic cues and the previous screenshot embeddings, a top subset of previous screenshots may be determined. For example, during a first phase of processing by one or more ML models, the set of previous screenshot embeddings for each previous screenshot may be compared to the semantic cues. A top subset of previous screenshot embeddings having top similarity to the semantic cues may be determined. Based on the top subset of previous screenshot embeddings, a corresponding top subset of previous screenshots (e.g., top-K previous screenshots) may be determined.

At extract operation 432, during a second phase of processing, based on the semantic cues (and/or a fine semantic prompt) defined for the selected plugin, one or more entities may be extracted from the top subset of previous screenshots. In aspects, the extracted entities may be output based on formatting specified by the semantic cues (and/or a semantic prompt) defined for the selected plugin, the formatting being suited for executing the selected plugin.

In aspects, one or more operations 422-432 may be implemented using a generative machine learning model, described further with reference to FIGS. 5A-5B.

At execute operation 434, the selected plugin may be executed. If determination operation 422 branched “NO,” the selected plugin may be executed without recall from semantic memory, e.g., based on a script. Alternatively, if determination operation 422 branched “YES,” the selected plugin may be executed using the extracted one or more entities. Thus, in addition to determining activity triggers for a top subset of plugins for performing a second activity (e.g., reserving a rental car) directly or indirectly related to performing a first activity (e.g., booking a flight), the present disclosure automatically extracts relevant content or context (e.g., one or more entities) from memory for executing a selected plugin of the top subset of plugins. In this way, not only is the user benefited by the automatic identification of relevant plugins, but also by the automatic populating of a selected plugin with relevant entities for execution.

As should be appreciated, operations 402-434 are described for purposes of illustrating the present methods and systems and are not intended to limit the disclosure to a particular sequence of steps, e.g., operations may be performed in a different order and more or fewer operations may be performed without departing from the present disclosure.

FIGS. 5A and 5B illustrate overviews of an example generative machine learning model that may be used according to aspects described herein. With reference first to FIG. 5A, conceptual diagram 500 depicts an overview of pre-trained generative model package 504 that processes a input 502 and, for example, a prompt, to generate model output 506 associated with aspects described herein, such as detecting an activity trigger for calling a plugin based on evaluating a current screenshot and/or extracting entities from previous relevant screenshots for executing the plugin. Examples of pre-trained generative model package 504 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that input 502 includes a prompt that is generated, selected, or otherwise engineered to induce generative model package 504 to produce certain generative model output 506. For example, a prompt includes a context and/or one or more completion prefixes that thus preload generative model package 504 accordingly. As a result, generative model package 504 is induced to generate output based on the prompt that includes a predicted sequence of tokens (e.g., up to a token limit of generative model package 504) relating to the prompt. In examples, the predicted sequence of tokens is further processed (e.g., by output decoding 516) to yield generative model output 506. For instance, each token is processed to identify a corresponding word, word fragment, or other content that forms at least a part of generative model output 506. It will be appreciated that input 502 and generative model output 506 may each include any of a variety of content types, including, but not limited to, text output, image output, audio output, video output, programmatic output, and/or binary output, among other examples. In examples, input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2A-2C, 3A-3D, and 4A-4B). Accordingly, generative model package 504 operates as a tool with which machine learning processing is performed, in which certain inputs to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., computing device 104 in FIG. 1) or may be accessed remotely from a machine learning service (e.g., machine learning service 102). In other examples, aspects of generative model package 504 are distributed across multiple computing devices. In some instances, generative model package 504 is accessible via an application programming interface (API), as may be provided by an operating system of the computing device 104 and/or by the machine learning service 102, among other examples.

With reference now to the illustrated aspects of generative model package 504, generative model package 504 includes input tokenization 508, input embedding 510, model layers 512, output layer 514, and output decoding 516. In examples, input tokenization 508 processes input 502 to generate input embedding 510, which includes a sequence of symbol representations that corresponds to input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes input 502 and a prompt, aspects of which may be similar to context from semantic memory 124/176/196, and/or a prompt that was generated based on a prompt template of a library 122/174/194, according to aspects described herein.

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 504 in FIG. 5A or encoder 552 and decoder 554 in FIG. 5B) to generate a series of output tokens (e.g., words), for example which are then combined to yield a complete sentence (and/or any of a variety of other content). It will be appreciated that other generative models may generate multiple output tokens in a single iteration and may thus used a reduced number of iterations or a single iteration.

Accordingly, output probabilities 596 may thus form output 506 according to aspects described herein, such that the output of the generative ML model (e.g., which may include structured output) is used as input for subsequent processing according to aspects described herein. In other examples, output 506 is provided as generated output after processing input 502, according to the disclosed aspects.

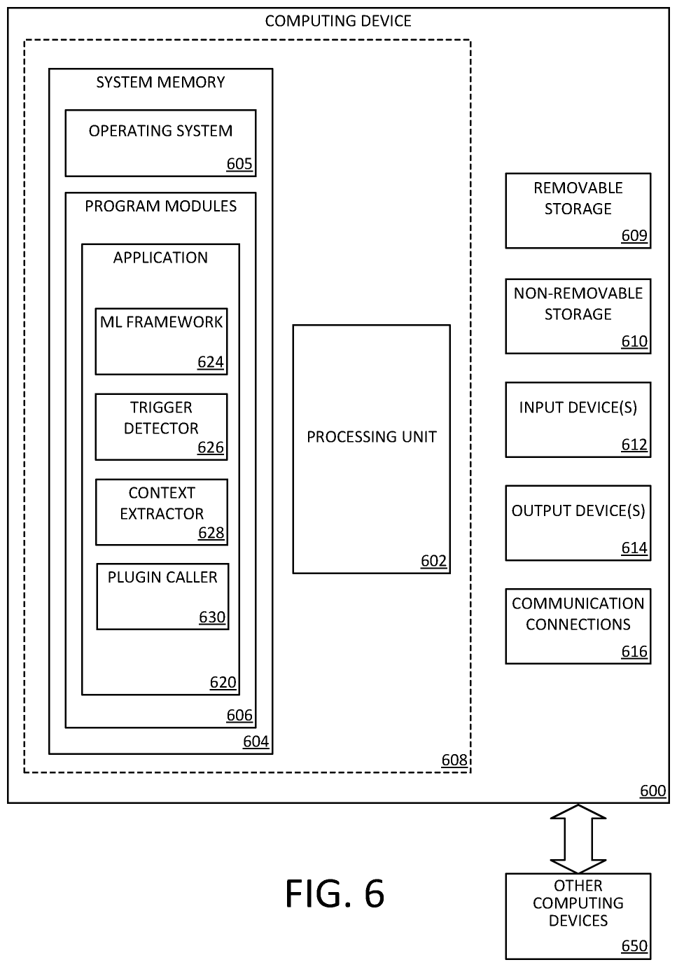

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with machine learning service 102, as well as computing device 104 discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store program modules 606, including application 620 (e.g., AI copilot application 180 or AI copilot platform 110). Application 620 may further include ML framework 624, trigger detector 626, content extractor 628, and plugin caller 630. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules 606 and data files may be stored in the system memory 604. While executing on the processing unit 602, the program modules 606 (e.g., application 620) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

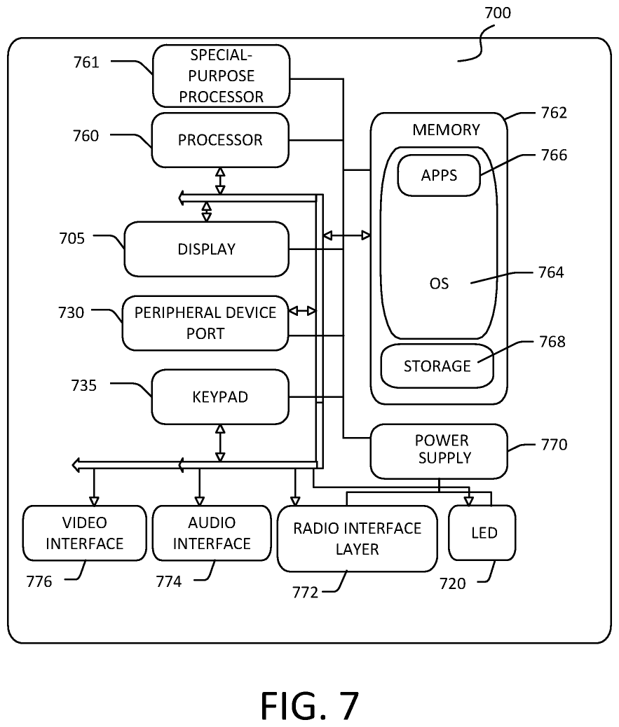

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

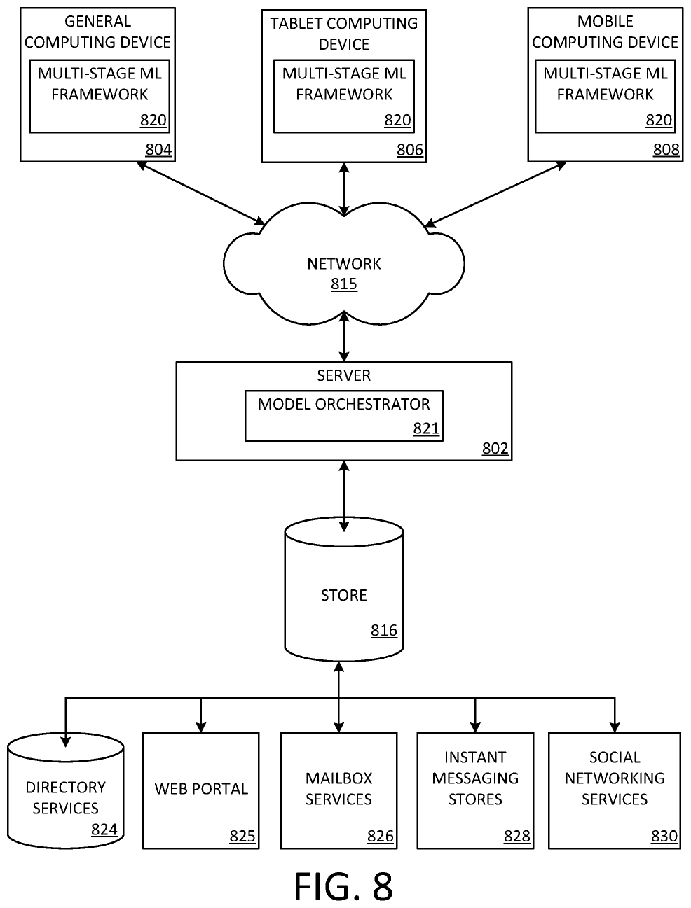

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

A multi-stage machine learning framework 820 (e.g., similar to ML framework 624 of application 620) may be employed by a client that communicates with server device 802. Additionally, or alternatively, model orchestrator 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In an aspect, a system is provided, the system including at least one processor and memory storing instructions that, when executed by the at least one processor, cause the system to perform a set of operations. The set of operations include capturing a current screenshot of a window associated with performing a first activity and processing image information associated with the current screenshot into a set of current screenshot embeddings. The operations further include receiving a plurality of trigger embeddings for a plurality of trigger screenshots defined for a plurality of plugins and determining semantic similarities between the set of current screenshot embeddings and the plurality of trigger embeddings. Additionally, the operations include determining a top subset of trigger screenshots of the plurality of trigger screenshots having greater semantic similarity to the current screenshot and detecting an activity trigger for each plugin of a top subset of plugins corresponding to the top subset of trigger screenshots, where each plugin is associated with performing a second activity related to the first activity.

In further aspects of the system described above, where the first activity is performed using one of an application, a website, or a plugin displayed in the window. In additional aspects, the operations including causing display of a notification regarding the activity trigger for each plugin of the top subset of plugins, wherein each plugin is selectable from the notification. Further, the system where the image information of the current screenshot is processed using one or more machine learning (ML) models. Additionally, the system where the one or more ML models includes at least one of a screen region detection function or a semantic embedding model. In further aspects, the system where each trigger screenshot of the plurality of trigger screenshots is processed using one or more ML models, and wherein the one or more ML models includes at least one of a screen region detection function or a semantic embedding model.

In additional aspects of the system described above, the operations further including receiving a selection of a plugin of the top subset of plugins and receiving at least one semantic cue defined for the selected plugin. Additionally, the operations including receiving a plurality of previous screenshot embeddings based on processing a plurality of previous screenshots and determining semantic similarities between the plurality of previous screenshot embeddings and the at least one semantic cue. Further, the operations including determining a top subset of previous screenshots having greater semantic similarity to the at least one semantic cue. Based on the at least one semantic cue, the operations also including extracting at least one entity from the top subset of previous screenshots and using the at least one entity for executing the selected plugin. Further, the operations including using one or more machine learning (ML) models to extract the at least one entity based on the at least one semantic cue.

In another aspect, a method of detecting an activity trigger for one or more plugins is provided. The method including capturing a current screenshot of a window associated with performing a first activity and processing image information associated with the current screenshot into a set of current screenshot embeddings. Additionally, the method including receiving a plurality of trigger embeddings for a plurality of trigger screenshots defined for a plurality of plugins and determining semantic similarities between the set of current screenshot embeddings and the plurality of trigger embeddings. The method further including determining a top subset of trigger screenshots of the plurality of trigger screenshots having greater semantic similarity to the current screenshot and detecting an activity trigger for each plugin of a top subset of plugins corresponding to the top subset of trigger screenshots, where each plugin is associated with performing a second activity related to the first activity. Additionally, the method including causing display of a notification regarding the activity trigger for each plugin of the top subset of plugins, wherein each plugin is selectable from the notification.

In further aspects of the method described above, where the image information of the current screenshot is processed using one or more machine learning (ML) models, and wherein the one or more ML models includes at least one of a screen region detection function or a semantic embedding model. Additionally, the method including receiving a selection of a plugin of the top subset of plugins and receiving at least one semantic cue defined for the selected plugin. The method further including receiving a plurality of previous screenshot embeddings based on processing a plurality of previous screenshots and determining semantic similarities between the plurality of previous screenshot embeddings and the at least one semantic cue. Additionally, the method including determining a top subset of previous screenshots having greater semantic similarity to the at least one semantic cue. Based on the at least one semantic cue, the method also including extracting at least one entity from the top subset of previous screenshots and using the at least one entity for executing the selected plugin. Further, the method including using one or more machine learning (ML) models to extract the at least one entity based on the at least one semantic cue.

In another aspect, a method of detecting an activity trigger for one or more plugins is provided. The method including capturing a current screenshot of a window associated with performing a first activity and using one or more machine learning (ML) models to process image information associated with the current screenshot into a set of current screenshot embeddings. The method further including receiving a plurality of trigger embeddings for a plurality of trigger screenshots defined for a plurality of plugins and determining semantic similarities between the set of current screenshot embeddings and the plurality of trigger embeddings. Additionally, the method including determining a top subset of trigger screenshots of the plurality of trigger screenshots having greater semantic similarity to the current screenshot and detecting an activity trigger for each plugin of a top subset of plugins corresponding to the top subset of trigger screenshots, wherein each plugin is associated with performing a second activity related to the first activity.

In further aspects of the method described above, where the plurality of trigger screenshots is processed using one or more machine learning (ML) models, and where the one or more ML models includes at least one of a screen region detection function or a semantic embedding model. The method further including receiving a selection of a plugin of the top subset of plugins and receiving at least one semantic cue defined for the selected plugin. Additionally, the method including receiving a plurality of previous screenshot embeddings based on processing a plurality of previous screenshots and determining semantic similarities between the plurality of previous screenshot embeddings and the at least one semantic cue. The method also including determining a top subset of previous screenshots having greater semantic similarity to the at least one semantic cue.

In further aspects of the method described above, the method including receiving a semantic prompt defined for the selected plugin and based on the semantic prompt, extracting at least one entity from the top subset of previous screenshots and using the at least one entity for executing the selected plugin. The method also including using one or more machine learning (ML) models to process the semantic prompt to extract the at least one entity. Additionally, the method including causing display of a notification regarding the activity trigger for each plugin of the top subset of plugins, where each plugin is selectable from the notification.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
capturing a current screenshot of a window associated with performing a first activity;
processing image information associated with the current screenshot into a set of current screenshot embeddings;
receiving a plurality of trigger embeddings for a plurality of trigger screenshots defined for a plurality of plugins;
determining semantic similarities between the set of current screenshot embeddings and the plurality of trigger embeddings;
determining a top subset of trigger screenshots of the plurality of trigger screenshots having greater semantic similarity to the current screenshot; and
detecting an activity trigger for each plugin of a top subset of plugins corresponding to the top subset of trigger screenshots, wherein each plugin is associated with performing a second activity related to the first activity.

2. The system of claim 1, wherein the first activity is performed using one of an application, a website, or a plugin displayed in the window.

3. The system of claim 1, the set of operations further comprising:
causing display of a notification regarding the activity trigger for each plugin of the top subset of plugins, wherein each plugin is selectable from the notification.

4. The system of claim 1, wherein the image information of the current screenshot is processed using one or more machine learning (ML) models.

5. The system of claim 4, wherein the one or more ML models includes at least one of a screen region detection function or a semantic embedding model.

6. The system of claim 1, wherein each trigger screenshot of the plurality of trigger screenshots is processed using one or more ML models, and wherein the one or more ML models includes at least one of a screen region detection function or a semantic embedding model.

7. The system of claim 1, the set of operations further comprising:
receiving a selection of a plugin of the top subset of plugins;
receiving at least one semantic cue defined for the selected plugin;
receiving a plurality of previous screenshot embeddings based on processing a plurality of previous screenshots;
determining semantic similarities between the plurality of previous screenshot embeddings and the at least one semantic cue; and
determining a top subset of previous screenshots having greater semantic similarity to the at least one semantic cue.

8. The system of claim 7, the set of operations further comprising:
based on the at least one semantic cue, extracting at least one entity from the top subset of previous screenshots; and
using the at least one entity for executing the selected plugin.

9. The system of claim 8, the set of operations further comprising:
using one or more machine learning (ML) models to extract the at least one entity based on the at least one semantic cue.

10. A method of detecting an activity trigger for one or more plugins, comprising:
capturing a current screenshot of a window associated with performing a first activity;
processing image information associated with the current screenshot into a set of current screenshot embeddings;
receiving a plurality of trigger embeddings for a plurality of trigger screenshots defined for a plurality of plugins;
determining semantic similarities between the set of current screenshot embeddings and the plurality of trigger embeddings;
determining a top subset of trigger screenshots of the plurality of trigger screenshots having greater semantic similarity to the current screenshot;
detecting an activity trigger for each plugin of a top subset of plugins corresponding to the top subset of trigger screenshots, wherein each plugin is associated with performing a second activity related to the first activity; and
causing display of a notification regarding the activity trigger for each plugin of the top subset of plugins, wherein each plugin is selectable from the notification.

11. The method of claim 10, wherein the image information of the current screenshot is processed using one or more machine learning (ML) models, and wherein the one or more ML models includes at least one of a screen region detection function or a semantic embedding model.

12. The method of claim 10, further comprising:
receiving a selection of a plugin of the top subset of plugins;
receiving at least one semantic cue defined for the selected plugin;
receiving a plurality of previous screenshot embeddings based on processing a plurality of previous screenshots;
determining semantic similarities between the plurality of previous screenshot embeddings and the at least one semantic cue; and
determining a top subset of previous screenshots having greater semantic similarity to the at least one semantic cue.

13. The method of claim 12, further comprising:
based on the at least one semantic cue, extracting at least one entity from the top subset of previous screenshots; and
using the at least one entity for executing the selected plugin.

14. The method of claim 13, further comprising:
using one or more machine learning (ML) models to extract the at least one entity based on the at least one semantic cue.

15. A method of detecting an activity trigger for one or more plugins, comprising:
capturing a current screenshot of a window associated with performing a first activity;
using one or more machine learning (ML) models to process image information associated with the current screenshot into a set of current screenshot embeddings;
receiving a plurality of trigger embeddings for a plurality of trigger screenshots defined for a plurality of plugins;
determining semantic similarities between the set of current screenshot embeddings and the plurality of trigger embeddings;
determining a top subset of trigger screenshots of the plurality of trigger screenshots having greater semantic similarity to the current screenshot; and
detecting an activity trigger for each plugin of a top subset of plugins corresponding to the top subset of trigger screenshots, wherein each plugin is associated with performing a second activity related to the first activity.

16. The method of claim 15, wherein the plurality of trigger screenshots is processed using one or more machine learning (ML) models, and wherein the one or more ML models includes at least one of a screen region detection function or a semantic embedding model.

17. The method of claim 15, further comprising:
receiving a selection of a plugin of the top subset of plugins;
receiving at least one semantic cue defined for the selected plugin;
receiving a plurality of previous screenshot embeddings based on processing a plurality of previous screenshots;
determining semantic similarities between the plurality of previous screenshot embeddings and the at least one semantic cue; and
determining a top subset of previous screenshots having greater semantic similarity to the at least one semantic cue.

18. The method of claim 17, further comprising:
receiving a semantic prompt defined for the selected plugin;
based on the semantic prompt, extracting at least one entity from the top subset of previous screenshots; and
using the at least one entity for executing the selected plugin.

19. The method of claim 18, further comprising:
using one or more machine learning (ML) models to process the semantic prompt to extract the at least one entity.

20. The method of claim 15, further comprising:
causing display of a notification regarding the activity trigger for each plugin of the top subset of plugins, wherein each plugin is selectable from the notification.
